(19) United States
(12) Patent Application Publication
(10) Pub. No.: US 2020/0232586 A1
(43) Pub. Date: Jul. 23, 2020

(54) Pipe, in Particular Plastic Pipe for Wastewater Lines

(71) Applicant: Lutec GmbH Verwaltungs- und Beteiligungsgesellschaft, Goldenstedt-Lutten (DE)

(72) Inventor: Gregor Lüers, Goldenstedt-Lutten (DE)

(21) Appl. No.: 16/629,935

(22) PCT Filed: Jun. 28, 2018
(86) PCT No.: PCT/EP2018/067398

§ 371 Date: Jan. 9, 2020

(30) Foreign Application Priority Data
Jul. 11, 2017 (EP) EP17180713.4

(51) Int. Cl. F16L 21/04; F16L 47/10

(52) U.S. Cl. CPC F16L 21/04; F16L 21/08; F16L 47/10

(57) ABSTRACT

The invention relates to a pipe, in particular a plastic pipe for wastewater lines, which has at least one socket end which is provided with an annular bead (4) and a socket neck (3) and forms a first pipe (1) into the socket end of which the spigot end of a second pipe or shaped part (13) can be plugged and removed again therefrom, and in which an elastic annular seal (6) is inserted into the annular bead (4). According to the invention, the socket neck (3) of the pipe is provided with a screw thread (9) onto which there can be screwed a screw ring (8) which comprises an inner ring part (10) and an outer ring part (11) between which an annular gap is formed, and the ring parts (10, 11) are connected by means of a ring base (12) facing away from the annular bead (4), wherein, upon screwing the screw ring (8) onto the screw thread (9), the front edge (14) of the inner ring part (10) compresses the annular seal (6) inserted into the annular bead (4) and arrests the spigot end of the second pipe or shaped part (13) in the first pipe (1).

The invention relates to a pipe, in particular a plastic pipe for wastewater lines, according to the preamble of claim 1.

For decades, plastic sewer pipes have been used to drain wastewater or rainwater from individual lengths of pipe. A socket end of such a pipe is provided with a bead in which an annular seal or lip seal is inserted. To connect two pipes, the spigot end of another pipe is inserted into the socket, whereby the seal is pressed between the bead base of the bead and the surface of the spigot end of the inserted pipe. The same principle is used to form shaped parts, such as bends, branches, sliding sockets, double sockets, reducers, etc. A compromise has to be found between the requirement for high tightness and the possibility of being able to assemble the pipes without excessive effort. Such pipe systems are therefore only approved for use without pressure. Since the sealing principle only permits limited compression of the seal used, such pipe systems can only be used to a limited extent in groundwater protection areas.

The force required to connect two pipes depends on the pipe diameter and the type of seal used. Such pipes or shaped parts also have a bevel or “chamfer” at the spigot end. This is necessary to allow insertion into the annular seal. Usually the seal and the spigot end of the pipe or shaped part to be inserted are provided with a lubricant to minimize friction and the required insertion force. If, in unfavorable tolerance conditions, the seal used is partially or completely pushed out of the bead into the socket when the spigot end of a pipe is pushed forward into a socket, this can lead to leaks and a narrowing of the pipe cross-section.

It is often necessary to carry out a trial installation first. For this purpose, the annular seal is removed from the bead and the pipes are put together for a trial. Once the correct shaped parts have been found and the lengths of pipe have been determined, the annular seal is inserted back into the bead of the socket and the pipe ends are put together. It cannot be ruled out that the insertion of the annular seal may be forgotten and that the fault may only be detected after the wastewater line has been put into operation.

In order to change a wastewater line, it is often necessary to separate existing pipe systems. This is very difficult and in many cases impossible if the pipe has been laid for a long time. In the case of so-called temporary structures, e.g. toilet facilities on fairgrounds, construction site drainage or temporary drainage, wastewater lines often have to be temporarily put together and disconnected again. With existing systems, this is very time-consuming.

For hose connections, e.g. garden hose systems, it is known to use screw fittings which can be screwed onto a connecting piece at the end of a pipe, whereby the lamellas arranged in ring form by the screw fitting are pressed into the surface of the hose and create a pressure-resistant seal by pressing with a sleeve of the connecting piece.

In the area of pressurized water pipes for fixed lines, it is also known to place screw caps on connecting pieces in which a pipe to be fastened is fixed by lamellas of the connecting piece when a screw ring is screwed onto the connecting piece and the seal between the connecting piece and the pipe is created by means of an annular seal which presses against the surface of the pipe to be arrested. The tolerances to be observed are not achievable for large pipe diameters.

The invention is based on the task of specifying a pipe, in particular a plastic pipe for wastewater lines, which, in contrast to known systems, enables an improved seal for a spigot end of another pipe to be inserted into the plastic pipe and which enables easy assembly and disassembly of a pipe connection.

This task is solved by the invention stated in claim 1. Additional enhancements provided by the invention are indicated in dependent claims.

The invention is based on a pipe, in particular a plastic pipe for wastewater lines, which has at least one socket end which is provided with an annular bead and a socket neck, and forms a first pipe, into the socket end of which the spigot end of a second pipe can be inserted and removed again, and in which an elastic annular seal is inserted into the annular bead.

According to the invention, the socket neck of the pipe is provided with a screw thread, on which a screw ring can be screwed, which contains an inner ring part and an outer ring part, between which an annular gap is formed. The ring parts are connected via a ring base facing away from the annular bead. When the screw ring is screwed onto the screw thread, the front edge of the radially inner ring part compresses an annular seal inserted into the annular bead, whereby the sealing takes place and the spigot end of the second pipe is arrested in the first pipe.

If the screw ring of such a pipe is in the open position, the spigot end of a second pipe can be inserted into the socket end of the first pipe or removed from it again with almost no effort, even without chamfering. When tightening the screw ring, which contains an inner and an outer ring part, the inner ring part with its front edge compresses the annular seal inserted into the annular bead and thus presses the inserted annular seal. This arrests the spigot end of the second pipe in the first pipe. If such a screw connection is to be loosened again, this is done simply by turning the screw ring backwards, which relieves the load on the seal and enables the pipe sections to be separated easily. The fact that the screw ring contains an inner and an outer ring part reduces the risk of the screw connection being restricted in its function by contamination. The increased pressure of the compressed seal also prevents dirty water from entering the screw connection via the seal.

When cutting pipe ends to size, it is no longer necessary to taper or chamfer the spigot end, as the sealing ring is only compressed after it has been inserted. This makes trial installation much easier. A further advantage of this connection is that root ingrowth into the socket is prevented by the strong compression of the annular seal.

Contrary to the prior art, the contact pressure between the socket of the first pipe and the spigot end of the second pipe is not produced directly by the distance between the bead base of the bead and the shape and size of the seal and the surface of the spigot end of the second pipe, but by the axial contact pressure between the front edge of the screw ring and the seal, so that the required contact pressure is produced by sufficient rotation of the screw ring.

In a preferred embodiment of the invention, the screw thread is an internal thread formed on the inside of the socket neck, into which an external thread formed on the outside of the inner ring part of the screw ring can be screwed. The inner diameter of the outer ring part of the screw ring is larger than the outer diameter of the socket neck and the outer ring part surrounds the socket neck when the screw ring is screwed onto the inner thread, the socket neck being received in the annular gap between the outer and inner ring parts.

In an alternative embodiment, the screw thread is an external thread formed on the outside of the socket neck, onto which an internal thread of the screw ring formed on the inside of the outer ring part can be screwed.

Preferably, a pressure and sliding ring are inserted into the annular bead between the front edge of the inner ring part and the annular seal. This makes screwing easier as there is no direct contact between the screw ring and the annular seal.

The annular seal is preferably triangular, oval or wedge-shaped in cross-section, whereby in the case of a triangular design with rounded corners, its adjacent side runs radially to the seal ring axis and its outer opposite side runs parallel to the annular seal axis. This has the advantage that when the screw cap is screwed on, the annular seal is compressed via the pressure and sliding ring in such a way that the side of the annular seal that is situated opposite to the screw cap is pressed onto the bottom of the bead, opposite to the surface of the pipe to be inserted, while the end of the annular seal facing the pressure and sliding ring is pressed onto the spigot end of the second pipe when the screw cap is screwed on. The maximum tolerance of the pipes to be connected prevents the end of the seal opposite the screw ring from penetrating between the socket and the spigot end of the second pipe.

In a preferred embodiment of the annular seal, it is oval, whereby in the unloaded position its outer diameter essentially corresponds to the inner diameter of the annular bead. The pressure and sliding ring is designed in such a way that when the screw ring is screwed on, the oval seal, which is flat when not under load, straightens in the radial direction, fills the space in the bead almost completely and the restoring forces of the elastomer seal prevent it from falling out.

Another alternative usable annular seal in the form of a U-shaped profile has two flanks on an inner base side. If such an annular seal is inserted into a bead in such a way that the flanks of the U-shaped seal come into contact with the base or sides of the annular bead, the base side of the seal will come into contact with the surface of the spigot end of the second pipe when the seal is pressed together. To improve the sealing property of the U-shaped annular seal, it may have one or more protruding annular ribs on its outer base side.

The axial length of the outer ring part of the screw cap is preferably dimensioned in such a way that the front end of the outer ring part is guided to the outer rear flank of the annular bead when the screw ring is screwed onto the socket neck. This avoids, on the one hand, the formation of a gap between the screw cap and the bead and thus the prevention of the penetration of dirt into the screw cap, and, on the other hand, a defined stop in order to produce defined pressure properties of the seal.

To make it easier to determine whether a screw connection is open or closed, the socket neck of the first pipe can contain a colored mark indicating how far the screw ring has been screwed onto the socket neck. If this mark is still clearly visible, it means that the ring is not sufficiently screwed onto the socket neck.

To prevent the screw ring from accidentally falling off or being unscrewed from the thread, the thread may contain a stop to limit rotation, which prevents the screw cap from simply falling off or being removed from the screw thread.

Particularly with large pipe diameters, the forces required to screw on the screw cap can become high, so that the screw ring can be provided with an external profile or with other attachments for grasping by means of a suitable tool to facilitate screwing on or unscrewing.

Preferably, the outside diameter of the screw ring corresponds essentially to the outside diameter of the bead in order to produce a uniform diameter transition.

The invention is explained in more detail below using an embodiment:

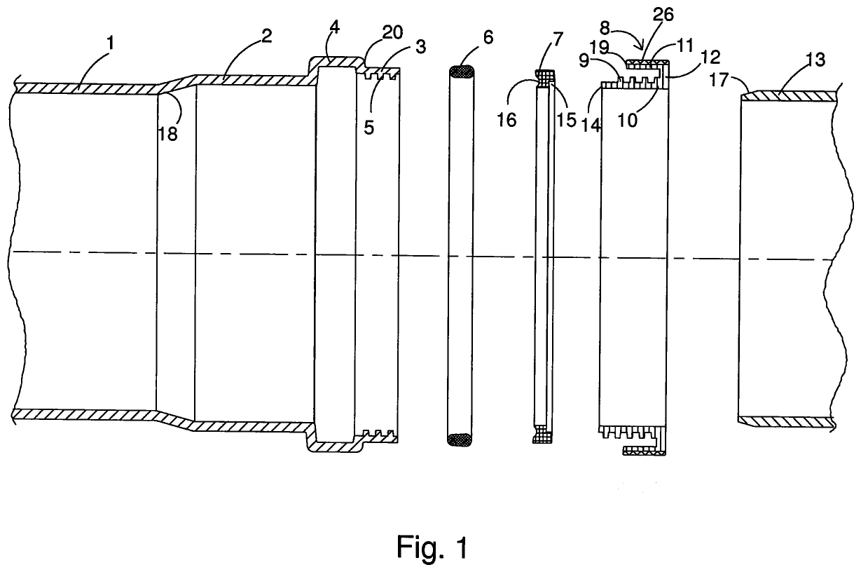

FIG. 1 shows an exploded view of the individual parts of a pipe connection according to the invention,

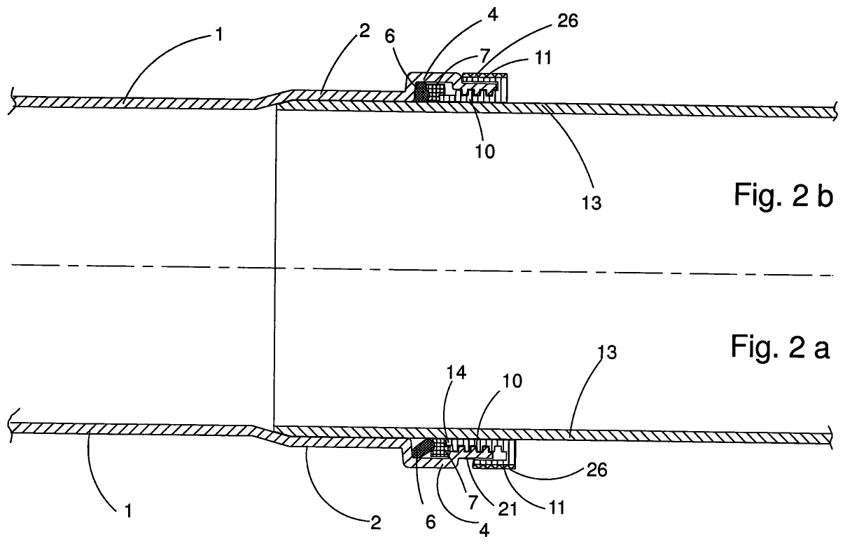

FIG. 2a shows a pipe connection with inserted spigot end of a second pipe into the socket end of a first pipe, whereby the screw cap is in its initial position and the annular seal used is relieved,

FIG. 2b shows a connection according to FIG. 2a in compressed condition,

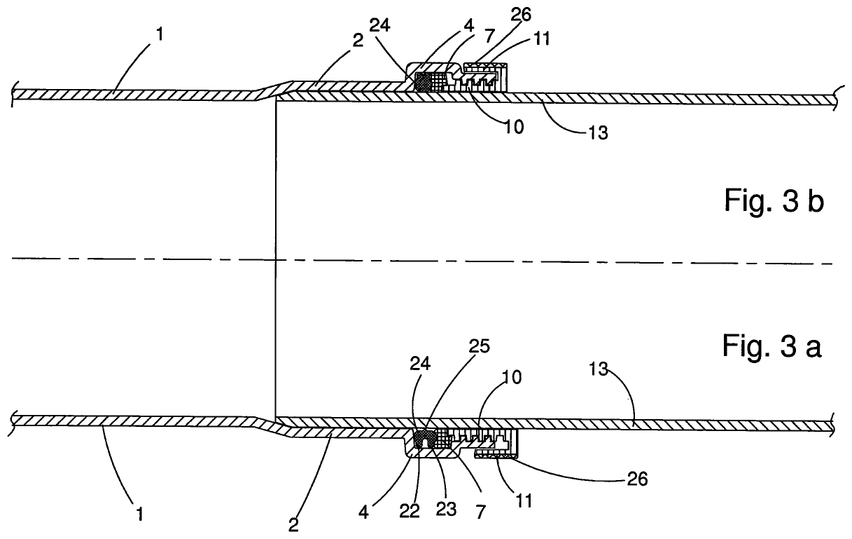

FIG. 3a shows a screw connection with a U-shaped seal in uncompressed condition,

FIG. 3b shows a screw connection with screwed-on screw cap and compressed seal, and

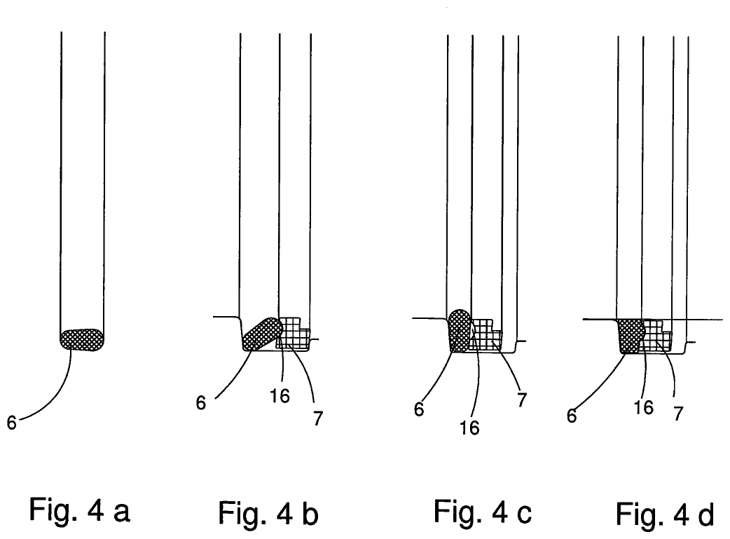

FIG. 4 a-d shows various positions of an oval annular seal in a bead.

FIG. 1 shows the details of a pipe connection according to the invention. A first pipe or shaped part 1 contains a socket 2 at its end, which forms an expansion of the pipe end via a bevel 18. An annular bead 4 is formed in the socket 2, in which an annular seal 6 can be received. Connected to the annular bead 4 at the end of the pipe is a socket neck 3, which has a screw thread 5 on its inside. There is also a pressure and sliding ring 7, which can be inserted into the annular bead 4 together with the oval annular seal 6.

A screw ring 8 contains an inner ring part 10 and an outer ring part 11, which are connected to each other on the side facing away from the pipe via the ring base 12. The inner ring part 10 contains on its radially outer surface a screw thread 9 for engagement in the screw thread 5 on the inside of the socket neck 3. The screw ring 8 serves to seal and fix the pipe connection of the pipe when the spigot end of a second pipe 13 is inserted into the socket 2 of the first pipe 1. The screw ring 8 serves to secure the second pipe or shaped part 13 in the first pipe 1.

To connect with the first pipe 1, the second pipe 13 is inserted with its spigot end into the socket 2 until the bevel 17 or the bluntly sawn-off spigot end of the second pipe 13 touches the bevel 18 in the socket 2 of the first pipe 1. Since the annular seal 6 does not project from the inside diameter of the socket 2 when the screw ring 8 is loosened and is therefore not under pressure in this condition, the second pipe 13 can easily be inserted into the first pipe 1.

At installation locations that are difficult to access, e.g. wall openings, under foundations or in narrowed pipe trenches, where there is no space for closing the connection, the pipe or shaped part can also be inserted into an already closed connection under more or less strong pressure. Lubricants must also be used for this, as is the case with conventional plug-in systems. The advantage over conventional systems, however, is that the annular seal is already clamped and cannot be pressed out of the bead.

To determine the sealing of the pipe connection, the screw ring 8 with its screw thread 9 is screwed into the screw thread 5 of the socket neck 3. FIG. 2a shows the provisional state of the connection. The screw ring 8 is screwed onto the socket neck of the first pipe so far that its front edge 14 has entered the shoulder 15 of the pressure and sliding ring 7. The oval annular seal 6, which is flat in the initial state, has already been pressed into a 45° position by special shaping of the pressure and sliding ring by means of an axially directed circumferential ring groove 16, whereby its end facing the pressure and sliding ring is directed towards the spigot end of the second pipe 13 and the end facing away from the pressure and sliding ring is located in a corner of the annular bead between the bead base and the adjacent flank of the annular bead. In this state of the pipe connection, in which there is no pressure on the seal in the radial direction, the spigot end of the second pipe 13 can easily be inserted into the socket or removed from the socket again.

The socket neck also has a circumferential marking 21, which is a colored marking and, depending on the apparent width, indicates an open state of the seal or a closed state by showing how far the screw ring has been screwed onto the screw thread.

FIG. 2b shows the condition of a closed pipe connection. Here the screw ring 8 is screwed onto the thread 5 so far that the front edge 19 of the outer ring part 11 touches the rear flank 20 of the annular bead 4. The front edge 14 of the inner ring part 10 has now displaced the pressure and sliding ring 7 in the axial direction of the pipe so far that the annular seal 6 is squeezed together and almost completely fills the remaining cavity of the annular bead. Marking 21 is no longer visible.

To separate the pipe connection, the screw ring 8 can be unscrewed easily from the socket neck either manually or using a suitable tool, so that the annular seal 6 is released and the spigot end of the second pipe can be pulled out of the first pipe again.

As the front edge 19 of the screw ring 8 in the condition shown in FIG. 2b touches the rear flank 20 of the bead, almost no dirt can enter between the socket neck 3 and screw ring 8 even in the installed condition of such a pipe connection. This also protects the threaded connection from dirt, so that even after a long time the screw connection can be easily loosened.

FIGS. 3a and 3b show the use of an alternative seal which is designed as a U-shaped seal in which two flanks 22 and 23 are directed against the bead base, and the seal base is in contact with the spigot end of the second pipe 13 inserted into pipe 1. Here, too, tightening the screw connection by means of the screw ring 8 causes the U-shaped seal 24 to be compressed via the pressure and sliding ring 7 and can take on the desired sealing function. To improve the sealing property, the annular seal 24 can also have a circumferential radially directed sealing rib 25, which provides an additional sealing function with respect to the surface of the second pipe 13.

FIGS. 4a-4d show various stages of an oval annular seal 6 inserted into an annular bead. In the unloaded state, seal 6 is a flat annular seal with a front part with a smaller radius and a rear part with a larger radius of curvature that is somewhat asymmetrical. As FIG. 4b shows, the pressure and sliding ring 7 has a front ring groove 16 into which the rear end of the annular seal 6 enters when the pressure and sliding ring is pushed forward. The annular seal 6 is pressed into a 45° position in which the end with a larger radius of curvature in the ring groove 16 comes into contact, while the end of the seal 6 with a smaller radius of curvature remains in the area between the bead base and the adjacent flank of the annular bead. If the screw ring is tightened further, the seal 6 will straighten into a radially directed shape via the pressure and sliding ring 7. When the spigot end is inserted, the seal is therefore compressed and takes on a shape as shown in FIG. 4d.

The straightening principle of the seal as shown in FIGS. 4a-d is the same when a triangular seal is used, which either straightens or is simply compressed when the screw connection is tightened. The invention also concerns other forms of seals which can be compressed by lateral pressure in such a way that their inner radius is sufficiently reduced with suitable lateral pressure.

The screw ring can be tightened or loosened manually or mechanically or, in the case of larger diameters in particular, by means of suitable gripping tools, whereby suitable profiling 26 on the outside of the screw ring facilitates the tightening or loosening of the screw ring.

The invention concerns not only the connection of two pipes with a spigot end and a socket, but also related pipe designs, such as a socket sleeve with a socket formed on both sides, into which two spigot ends of pipes can be inserted, branches, bends, reducers and similar designs. The term “second pipe” refers to all types of pipe forms which have at least one spigot end which can be inserted into a first pipe form with at least one socket end.

The invention is also suitable not only for unpressurized pipes, but also for pipelines for pressurized media.

The invention is particularly suitable for use in critical installation situations, such as in areas with special safety precautions, and with high sealing requirements. The invention can also be used to great advantage in situations where frequent assembly and separation of pipelines is required.

### REFERENCE NUMBERS

1 First pipe
2 Socket
3 Socket neck
4 Annular bead
5 Screw thread
6 Annular seal
7 Pressure and sliding ring
8 Screw ring
9 Screw thread
10 Ring part
11 Ring part
12 Ring base
13 Second pipe
14 Front edge
15 Shoulder
16 Ring groove
17 Bevel or chamfer
18 Bevel
19 Front edge
20 Rear flank
21 Marking
22 Flank
23 Flank
24 Annular seal
25 Rib
26 Profiling

1. Pipe, in particular plastic pipe for wastewater lines, which has at least one socket end which is provided with an annular bead (4) and a socket neck (3) and forms a first pipe (1), into the socket end of which the spigot end of a second pipe or shaped part (13) can be inserted and removed again, and in which an elastic annular seal (6, 24) is inserted into the annular bead (4), characterized in that the socket neck (3) of the pipe (1) is provided with a screw thread (5), onto which a screw ring (8) can be screwed, the screw ring containing an inner ring part (10) and an outer ring part (11), between which an annular gap is formed, and the ring parts (10, 11) are connected via a ring base (12) facing away from the annular bead (4), the front edge (14) of the inner ring part (10), when the screw ring (8) is screwed onto the screw thread (5), compressing the annular seal (6, 24) inserted into the annular bead (4) and arresting the spigot end of the second pipe or shaped part (13) in the first pipe (1).

2. Pipe according to claim 1, characterized in that the screw thread (5) is an internal thread formed on the inside of the socket neck (3), onto which an external thread formed on the outside of the inner ring part (10) of the screw ring (8) can be screwed, the inner diameter of the outer ring part (11) of the screw ring (8) being selected to be greater than the outer diameter of the socket neck (3), and the outer ring part (11) surrounding the socket neck (3) on the outside when the screw ring (8) is screwed onto the internal thread, and the socket neck (3) being received in the annular gap.

3. Pipe according to claim 1, characterized in that the screw thread is an external thread formed on the outside of the socket neck (3), onto which an internal thread formed on the inside of the outer ring part (11) of the screw ring (8) can be screwed, the diameter of the outer ring part (11) of the screw ring (8) being selected to be greater than the outer diameter of the socket neck (3), and the outer ring part (11) surrounding the socket neck (3) on the outside when the screw ring (8) is screwed onto the external thread, and the socket neck (3) being received in the annular gap.

4. Pipe according to claim 1, characterized in that a pressure and sliding ring (7) is inserted into the annular bead (4) between the front edge of the inner ring part (10) and the annular seal (6).

5. Pipe according to claim 1, characterized in that the annular seal (6) is oval in cross-section.

6. Pipe according to claim 4, having an annular seal (6) inserted into the annular bead (4), characterized in that the pressure and sliding ring (7) has on its side facing the annular seal (6) a ring groove (16) which, when the screw ring (8) is screwed on, causes a radial displacement of the rear edge of the annular seal (6) in the direction of the surface of a second pipe (13) to be inserted.

7. Annular seal for use in a pipe according to claim 1, characterized in that the annular seal (6) is of triangular or wedge shape in cross-section, its adjacent side running radially to the sealing ring axis and its opposite side running parallel to the sealing ring axis in the bead base.

8. Pipe according to claim 1, with said annular seal (24) inserted into the annular bead (4), characterized in that the opposite side of the annular seal is arranged in the bead base of the annular bead (4) and the adjacent side is directed towards the front edge of the inner ring part (10).

9. Pipe according to claim 1, characterized in that the annular seal (24) is U-shaped in cross-section with two flanks (22, 23) and an inner base side, the flanks (22, 23) of the annular seal (24) running radially to the seal ring axis.

10. Pipe according to claim 9, characterized in that the base side of the annular seal (24) is provided with a circumferential rib (25).

11. Pipe according to claim 9 with said annular seal (24) inserted into the annular bead (4), in which the base side of the annular seal (24) makes contact with the surface of the spigot end of the second pipe (13) and the flanks (22, 23) of the annular seal (24) in the bead base of the annular bead (4).

12. Pipe according to claim 1, characterized in that the outer ring part (11) has an axial length dimensioned such that a front edge of the outer ring part (11) is guided to an outer rear flank (20) of the annular bead (4) when the screw ring (8) is screwed onto the socket neck (3).

13. Pipe according to claim 1, characterized in that the socket neck (3) is provided with an outer contrasting marking (21) by means of which the connecting state of a pipe connection composed of a first pipe (1) and a second pipe (13) is visually recognizable.

14. Pipe according to claim 1, characterized in that the thread between the screw ring and the socket neck is provided with a latching lug which prevents the screw ring (8) from being unintentionally unscrewed from the screw thread (5) of the first pipe (1).

15. Pipe according to claim 1, characterized in that the screw ring (8) is provided with an outer profiling (26).

16. Pipe according to claim 1, characterized in that the outer diameter of the screw ring (8) corresponds to the outer diameter of the annular bead.
